(19) United States
(12) Patent Application Publication
(10) Pub. No.: US 2026/0225162 A1
(43) Pub. Date: Aug. 6, 2026

(54) HEAD FOR EXCHANGEABLE-HEAD CUTTING TOOL, AND CUTTING TOOL

(71) Applicant: TUNGALOY CORPORATION, Fukushima (JP)

(72) Inventors: Yuma KONDOU, Fukushima (JP); Jun OTSUKA, Fukushima (JP)

(73) Assignee: TUNGALOY CORPORATION, Fukushima (JP)

(21) Appl. No.: 19/448,647

(22) Filed: Jan. 14, 2026

(30) Foreign Application Priority Data
Feb. 6, 2025 (JP) 2025-018071

(51) Int. Cl. B23B 29/24; B23B 27/16

(52) U.S. Cl. CPC B23B 29/24; B23B 27/16

(57) ABSTRACT

By overcoming restrictions imposed by the tool post specification, the number and variety of cutting members that can be set in the tool post are increased, enabling efficient execution of various types of machining processes on a workpiece and thereby improving productivity. A head for an exchangeable-head cutting tool includes a mounting part for mounting the head on a component of the tool other than the head; and a plurality of mounting holes configured to receive a substantially rod-like cutting member.

### BACKGROUND

### Field

The present disclosure relates to a head for an exchangeable-head cutting tool, and a cutting tool having this head.

### Description of Related Art

In an automatic lathe that performs various types of machining processes such as drilling, internal grooving, and turning on a rotating workpiece (machining target), cutting tools having a rod-like cutting member, for example, secured to a holder are widely used. These cutting tools are mounted on a tool post, such as a rear tool post, B-axis tool post, or opposed tool post. These tool posts are typically designed to allow a large number of cutting tools to be mounted so that complex and various machining processes can be performed. However, cost limitations often restrict the type and number of tool posts, and there are also limitations on the type and number of tools that can be mounted on the tool post. As a solution to this problem, for example, Patent Publication JP-A-2007-62006 proposes a configuration that allows two rod-like cutting members to be attached to a single holder. This provides a cutting tool capable of multiple types of machining processes without increasing the number of tools mounted on the tool post.

### SUMMARY

The cutting tool disclosed in Patent Publication JP-A-2007-62006 still has the problem that it can be used only on a limited variety of tool posts. More specifically, in a conceivable configuration shown in FIG. 9A and FIG. 9B, a cutting tool 8A having one rod-like cutting member 81 secured to one end of a holder 82A is inserted into a mounting hole 91 of a tool post 9. To increase the number of cutting members 81, for example, a head 82B having two cutting members 81 can be attached to either end of the holder 82A as shown in FIG. 10. However, such a cutting tool 8B may not fit the mounting hole 91 of the tool post 9 because the head interferes with the mounting hole 91.

Accordingly, the present disclosure was made in view of the circumstances described above, with an object to provide a head that overcomes restrictions imposed by tool post specifications so that the number and variety of the cutting members that can be set in a tool post are increased, enabling efficient execution of various types of machining processes on a workpiece, and a cutting tool that includes this head.
[1] A head according to an example of the present disclosure is designed for an exchangeable-head cutting tool, and includes: a mounting part for mounting the head on a component of the exchangeable-head cutting tool other than the head; and a plurality of mounting holes configured to receive a substantially rod-like cutting member.

In this configuration, the head is removably mounted on the component of the exchangeable-head cutting tool. The head can be mounted on the component that is already set in a tool post, and a plurality of cutting members may then be attached to this head. Alternatively, the head already carrying a plurality of cutting members may be mounted on the component. Therefore, unlike the conventional cutting tool 8B (see FIG. 10), a cutting tool with a larger head carrying an increased number of cutting members can be set in the tool post 9 without interfering with the mounting hole 91 of the tool post 9. Restrictions imposed by the tool post specification are thus overcome, allowing an increase in the type and number of the cutting members that can be set in the tool post, and enabling tool exchange regardless of tool post type. This also enables various types of machining processes to be performed efficiently on a workpiece.
[2] The head may be substantially cuboidal except for the mounting part. The overall shape of the head can be formed to have a predetermined aspect ratio, so that the head thickness can be made equal to or less than the thickness of the component. This allows the head to be made small and lightweight, and when the cutting tool with a head mounted on the component set in the tool post, the cutting tool readily avoids interference with another adjacent cutting tools.
[3] The mounting holes may have their central axes located within the thickness of the component or within a width in a direction along a short side of the component. This allows the head to be made even smaller, enabling the head to avoid interference with the workpiece or adjacent cutting tools in the tool post. The component also provides support for the cutting edges of the cutting members that are subjected to the cutting forces during machining.
[4] The head may include a screw hole that extends laterally through to the plurality of mounting holes and receives a screw for securing a cutting member to the head. This allows the screw for securing the cutting member to be accommodated in the head, so that the head can be made even smaller. This configuration also allows the screw to be located at a readily visible position, so that the operation of fastening the cutting member to the head with the screw can be carried out reliably and easily. At the same time, an effective screw engagement length for the fastening of the cutting member is ensured.
[5] The mounting holes may have their central axes substantially parallel to the direction in which the head is fixed to the component. The mounting holes thus configured enable a further reduction in the size of the head, reliably preventing interference between the head and the workpiece or adjacent cutting tools in the tool post. These mounting holes enable configuration of a head that can efficiently perform various types of machining processes with substantially rod-like cutting members.
[6] The head may include a screw engagement length adjustment surface in which the screw holes are formed. This improves the ease of operating the screws, and allows the diagonal formation of the screw holes extending laterally toward the mounting holes. Therefore, while ensuring an effective engagement length of the screws for securing the cutting member to the head, the operation of fastening the screws is facilitated. The structure also helps reduce the volume of the head, enabling a further reduction in the weight of the head and the cutting tool.
[7] The head may include a curved surface having a predetermined radius of curvature, a central portion (region)/a middle portion (region) of the curved surface is the lowest toward an virtual plane that includes the central axes of the plurality of mounting holes, the central axes of the plurality of mounting holes being offset from a longitudinal central axis of the component toward an opposite side from a side on which the curved surface is formed. With this curved surface, the head can avoid interference with the machining target, such as a rod-like workpiece, even when another cutting tool is placed adjacent the cutting tool of the present disclosure, because the workpiece can be positioned on the side opposite to the curved surface. Therefore, while preventing interference between cutting tools, the installation density of cutting tools on the tool post is increased.
[8] As opposed to [4] above, the mounting holes may have their central axes extending substantially perpendicular to the direction in which the head is fixed to the component. This configuration also enables a further reduction in the size of the head, reliably preventing interference between the head and the workpiece or adjacent cutting tools in the tool post. These mounting holes enable configuration of a head that can efficiently perform various types of machining processes with the substantially rod-like cutting members.
[9] The plurality of mounting holes in the head may be located opposite each other. This allows cutting members to be protruded in opposite directions from the head, which increases the degree of freedom of machining processes on a workpiece.
[10 and 11] At least one of the plurality of mounting holes may extend through the head. Alternatively, all the mounting holes may extend through the head. In this case, a single hole allows one cutting member to be attached in either orientation. Alternatively, a single hole allows two cutting members to be attached from both sides. By providing two or more through holes, the number of rod-like tools that can be mounted can be increased even more. Moreover, a through hole will allow attachment and use of a rod-like tool having cutting edges on both ends.
[12] A cutting tool according to an example of the present disclosure is an exchangeable-head cutting tool, including a head according to the present disclosure having a mounting part and a plurality of mounting holes configured to receive a substantially rod-like cutting member; and a component formed in an elongated shape and having the head mounted on either end thereof.

According to the present disclosure, restrictions imposed by the tool post specification are overcome, so that the number and variety of cutting members that can be set in the tool post are increased. This enables various types of machining processes to be performed efficiently on a workpiece, thereby improving productivity.

### BRIEF DESCRIPTION OF DRAWINGS

FIG. 1A is a perspective view illustrating a cutting tool 1 according to a first embodiment, and FIG. 1B is an exploded perspective view illustrating a part of the cutting tool 1;

FIG. 2A and FIG. 2B are a right side view and a bottom view, respectively, illustrating the cutting tool 1;

FIG. 3A to FIG. 3E are a right side view, a top view, a bottom view, a front view, and a rear view, respectively, illustrating a shank member 10 that forms part of the cutting tool 1;

FIG. 4A to FIG. 4E are a right side view, a top view, a bottom view, a front view, and a rear view, respectively, illustrating a head 20 and a cutting member 30 that form part of the cutting tool 1;

FIG. 5 is a schematic diagram showing a side view of the cutting tool 1 set in a tool post;

FIG. 6A is a perspective view illustrating a cutting tool 2 according to a second embodiment, and FIG. 6B is a perspective view illustrating the cutting tool 2 and another cutting tool 6 placed adjacent each other;

FIG. 7A to FIG. 7D are a right side view, a top view, a left side view, and a front view, respectively, illustrating the cutting tool 2;

FIG. 8A is a perspective view illustrating a cutting tool 3 according to a third embodiment, and FIG. 8B is a perspective view illustrating a cutting tool 3′ according to a fourth embodiment;

FIG. 9A and FIG. 9B are schematic diagrams showing a side view of a conventional cutting tool 8A before and after it is mounted on a tool post, respectively; and

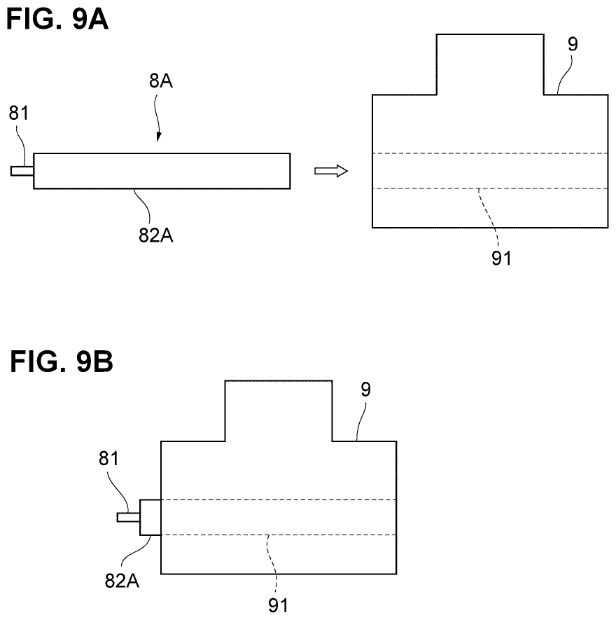

FIG. 10 is a schematic diagram showing a side view of a conventional cutting tool 8B before it is mounted on a tool post.

### DETAILED DESCRIPTION

Embodiments of the present invention are described below with reference to the accompanying drawings. For easier understanding of the description, the same constituent elements in the drawings are given the same reference numerals as much as possible and duplicate descriptions thereof will be omitted. The following embodiments of the present disclosure are described for illustrative purposes only, and should not be construed as limiting. Various modifications are possible within the scope of the present disclosure. A person skilled in the art can adopt an embodiment in which various elements described below are replaced with equivalents. These embodiments should also be included in the scope of the present disclosure.

### First Embodiment

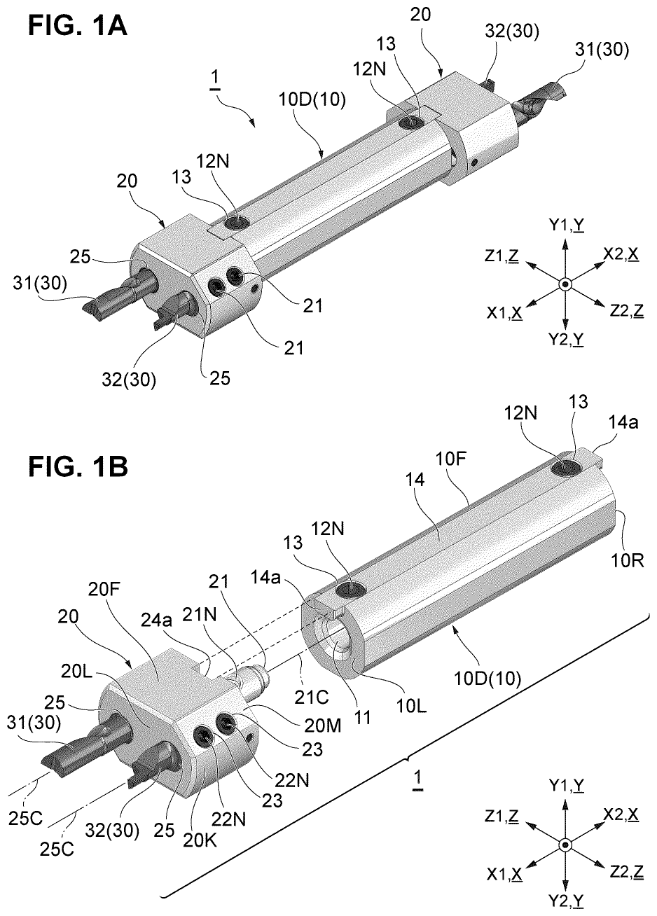

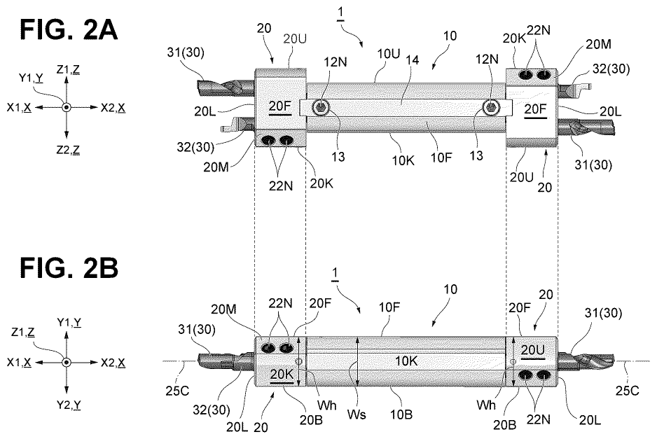

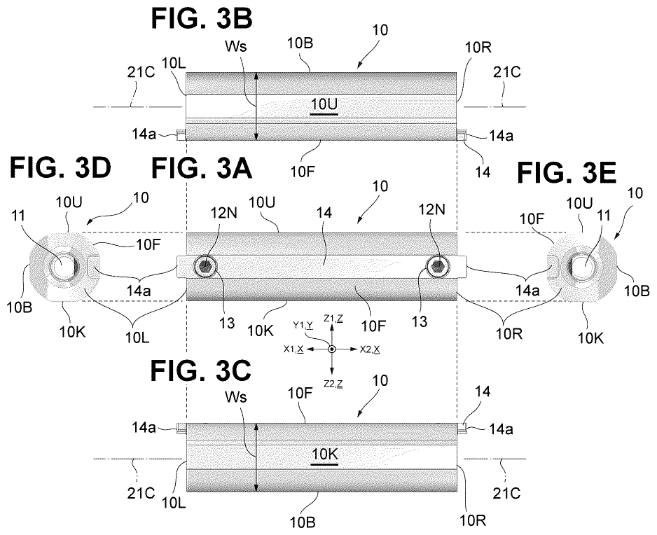

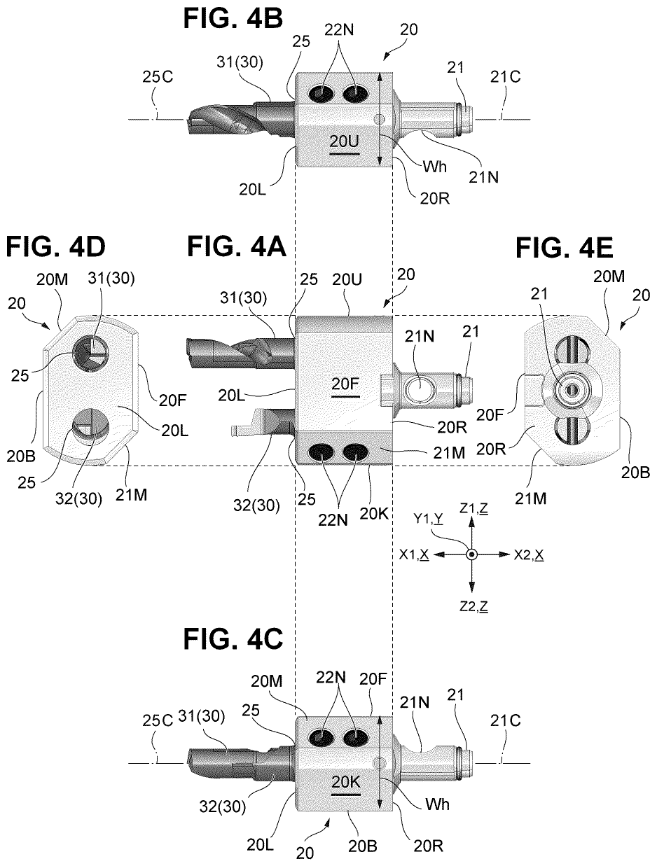

FIG. 1A is a perspective view illustrating a cutting tool 1 according to a first embodiment, and FIG. 1B is an exploded perspective view illustrating a part of the cutting tool 1. FIG. 2A and FIG. 2B are a right side view and a bottom view, respectively, illustrating the cutting tool 1. FIG. 3A to FIG. 3E are a right side view, a top view, a bottom view, a front view, and a rear view, respectively, illustrating a shank member 10 that forms part of the cutting tool 1. FIG. 4A to FIG. 4E are a right side view, a top view, a bottom view, a front view, and a rear view, respectively, illustrating a head 20 and a cutting member 30 that form part of the cutting tool 1. The coordinate axes shown in FIG. 3A to FIG. 3E and FIG. 4A to FIG. 4E apply to FIG. 3A and FIG. 4A, respectively.

In the present disclosure, the drawing sheet plane is used as a reference for convenience in explaining relative directions. Referring to the coordinate axes in FIG. 2A, FIG. 3A, FIG. 4A and others, the direction to the left may be referred to as “front X1,” and the opposite direction as “rear X2.” These directions may be collectively referred to as “front and back direction X.” In these drawings, the direction out of the plane of the drawing toward the viewer may be referred to as “right Y1,” and the opposite direction as “left Y2.” These directions may be collectively referred to as “left and right direction Y.” The upward direction may be referred to as “up (upper) Z1,” and the opposite direction as “down (lower) Z2.” These directions may be collectively referred to as “up and down direction Z.” In addition, a front view of a cutting tool 1 set in a tool post is seen from the front X1 to the rear X2, and a rear view is seen from the opposite direction. A right side view of the cutting tool 1 is seen from the right Y1 to the left Y2, and a left side view is seen from the opposite direction. A top view of the cutting tool 1 is seen from above (upper side Z1 to lower side Z2), and a bottom view is seen from the opposite direction.

As illustrated in these drawings, the cutting tool 1 according to this embodiment includes a shank member 10, two heads 20, and four cutting members 30. The shank member 10 includes a body part 10D extending linearly (in front and back direction X), and recessed parts 11 formed respectively on the front and rear surfaces (end surfaces) 10L and 10R of the body part for a projected part 21 of the head 20 to fit in. The shank member 10 is an example of “a component” in the present disclosure. The body part 10D serves as the shank (shaft portion of the component). The shank member 10 has screw holes 13 at both ends of its right side surface 10F, in which screws 12N are inserted to secure the heads 20. In other words, the screw holes 13, which the screws 12N engage to secure the heads 20 to the shank member 10, are formed to extend laterally through to the recessed parts 11 at both ends of a side wall 14 of the body part 10D. Further, keys 14a for the positioning of the heads 20 protrude out from the front surface 10L and rear surface 10R of the body part 10D.

The head 20 includes a projected part 21 that fits in the recessed part 11 on one of the front and rear surfaces 10L and 10R of the shank member 10. The head 20 is mounted on the shank member 10, with these recessed part 11 and projected part 21 fitted to each other, and with the rear surface 20R (flat contact surface) around the projected part 21 and the front surface 10L (flat contact surface) around the recessed part 11 making contact with each other. The projected part 21 of the head 20 is an example of a part of “a mounting part” in the present disclosure. The projected part 21 and the flat contact surface of the rear surface 20R are an example of the “mounting part” of the head in the present disclosure. The body of the projected part 21 is formed with an internal thread portion 21N for the screw 12N of the shank member 10 to engage. The head 20 is substantially in the form of a cuboid except for the projected part 21, having a thickness Wh (width in the left and right direction Y of the drawing) equal to the thickness Ws (width) of the shank member 10. The head 20 is further provided with a key groove 24a for the key 14a to fit in, at the boundary between the right side surface 20F and the rear surface 20R. The engagement between the key 14a and the key groove 24a enables the head 20 to be positioned relative to the shank member 10, so that the head 20 can be mounted easily and reliably on either end of the shank member 10.

The head 20 includes two mounting holes 25 in its front surface 20L for receiving rod-like tools 31 and 32 that are part of the cutting member 30 (an example of “a substantially rod-like cutting member” in the present disclosure). These mounting holes 25 have their central axes 25C located within the thickness Ws (width) of the shank member 10 (FIG. 2B). The central axes 25C extend substantially parallel to the direction 21C in which the head 20 is fixed to the shank member 10 (front and back direction X) as shown in FIG. 1B. The fixing direction 21C and the central axes 25C are not shown in FIG. 3A and FIG. 4A due to space restrictions.

Further, the head 20 includes a screw engagement length adjustment surface 20M between the right side surface 20F and the lower surface 20K and between the left side surface 20B and the upper surface 20U, which is a flat surface connecting these surfaces. The screw engagement length adjustment surface 20M is a flat surface substantially parallel to the head parts of the screws 22N. Each screw engagement length adjustment surface 20M has two screw holes 23 (an example of “a screw hole” in the present disclosure) aligned along the axial direction of the mounting holes 25, in which the screws 22N are inserted to secure each of the rod-like tools 31 and 32 to the head 20. In other words, the screw holes 23, which the screws 22N engage to secure the rod-like tools 31 and 32 to the head 20, are formed to extend laterally through to each mounting hole 25 at a predetermined angle relative to the XZ plane.

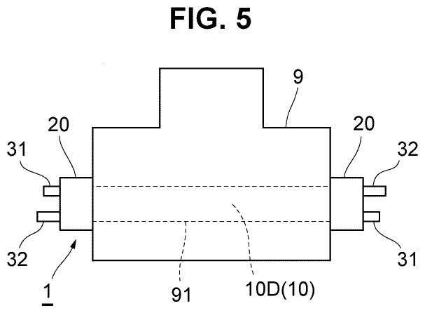

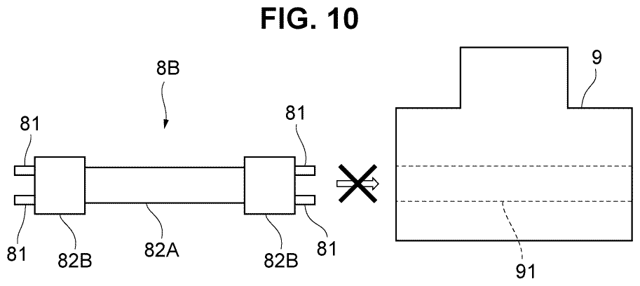

The exchangeable-head cutting tool 1 according to the first embodiment of the present disclosure is configured as described above such that the head 20 is removably mounted on the shank member 10. As illustrated in the schematic diagram of FIG. 5, the head 20 may be mounted on the shank member 10 that is already set in the tool post 9. The cutting member 30 may then be attached to this head 20. Alternatively, the head 20 already carrying the cutting member 30 may be mounted on the shank member 10. Therefore, unlike the conventional cutting tool 8B (see FIG. 10), the cutting tool 1 with the larger head 20 carrying an increased number of rod-like tools can be set in the tool post 9 without interfering with the mounting hole 91 of the tool post 9. Restrictions imposed by the tool post specification are thus overcome, allowing an increase in the type and number of the rod-like tools 31 and 32 that can be set in the tool post, and enabling tool exchange regardless of tool post type. This enables various types of machining processes to be performed efficiently on a workpiece, thereby improving productivity.

Since the head 20 is substantially cuboidal except for the projected part 21, the overall shape of the head 20 can be formed to have a thin profile with a predetermined aspect ratio, as in this embodiment. Accordingly, the thickness Wh (width) of the head can be made equal to or less than the thickness Ws (width) of the shank member. This allows the head 20 to be made small and lightweight, and when the cutting tool 1 with a head 20 mounted on the shank member 10 set in the tool post, the cutting tool readily avoids interference with another adjacent cutting tools. This allows the installation density of cutting tools on the tool post to be increased, thereby enhancing productivity. The shank member 10 and the head 20 having the same thickness are flush with each other and facilitate a reduction in the overall thickness of the cutting tool 1. This allows the cutting tool 1 to avoid interference with adjacent cutting tools more easily when set in the tool post.

The mounting holes 25 having their central axes 25C located within the thickness Ws of the shank member 10 (FIG. 2B) also help reduce the size of the head 20. By avoiding interference between the head 20 and the workpiece or adjacent cutting tools set in the tool post, the installation density of cutting tools on the tool post can be increased, whereby productivity is enhanced. Since the shank member 10 provides support for the cutting edges of the rod-like tools 31 and 32 that are subjected to the cutting forces during machining, the overall rigidity of the cutting tool 1 is enhanced.

Moreover, the screw holes 23, which the screws 22N engage to secure the rod-like tools 31 and 32 to the head 20, are formed to extend laterally through to the mounting holes 25 at a predetermined angle relative to the XZ plane. This allows the screws 22N for securing the rod-like tools 31 and 32 to be accommodated in the head 20, so that the head 20 can be made even smaller. This configuration also allows the screws 22N and screw holes 23 to be located at readily visible positions, so that the operation of fastening the rod-like tools 31 and 32 to the head 20 with the screws can be carried out reliably and easily. At the same time, an effective screw length for the fastening of the rod-like tools 31 and 32 is ensured.

The mounting holes 25 having their central axes 25C extending substantially parallel to the direction 21C (front and back direction X) in which the head 20 is fixed to the shank member 10 (FIG. 1B) enable a further size reduction of the head 20. This reliably prevents interference between the head 20 and the workpiece or adjacent cutting tools set in the tool post, enabling a further increase in the installation density of cutting tools on the tool post, and thereby enhancing productivity. These mounting holes 25 enable configuration of a head 20 that can efficiently perform various types of machining processes with the rod-like tools 31 and 32.

Further, the head 20 includes a screw engagement length adjustment surface 20M, which is a flat surface substantially parallel to the head parts of the screws 22N, between the right side surface 20F and the lower surface 20K and between the left side surface 20B and the upper surface 20U, and the screw holes 23 are formed in this screw engagement length adjustment surface 20M. This improves the ease of operating the screws 22N, and allows the diagonal formation of the screw holes 23 extending laterally toward the mounting holes 25. Therefore, while ensuring an effective length of the screws 22N for securing the rod-like tools 31 and 32 to the head 20, the operation of fastening the screws 22N is facilitated. The structure also helps reduce the volume of the head 20, enabling a further reduction in the weight of the head 20 and the cutting tool 1.

The head 20 has a projected part 21 that fits in the recessed part 11 of the shank member 10. The head 20 is mounted on the shank member 10, with these recessed part 11 and projected part 21 fitted to each other, and with the rear surface 20R (flat contact surface) around the projected part 21 and the front surface 10L (flat contact surface) around the recessed part 11 making contact with each other. Since the head 20 is pressed against the flat contact surface of the shank member 10 when secured thereto, the cutting tool 1 is made compact and takes up a reduced installation space in the tool post. Since the projected part 21 is inserted in the recessed part 11 when the head 20 and the shank member 10 are fastened together with the screws 12N, the shank member 10 can firmly hold the head 20.

Moreover, the screw hole 13, which the screw 12N engages to secure the head 20 to the shank member 10, is formed to extend laterally through to the recessed part 11. This allows the screw 12N for securing the head 20 to be accommodated in the shank member 10, so that the shank member 10 can be made even smaller. This configuration also allows the screw 12N and screw hole 13 to be located at a readily visible position, so that the operation of fastening the head 20 to the shank member 10 with the screw can be carried out reliably and easily.

The recessed part 11 of the shank member 10 having its central axis extending substantially parallel to the direction 21C (front and back direction X) in which the head 20 is fixed to the shank member 10 (FIG. 1B) enables a further size reduction of the shank member 10. This reliably prevents interference between the head 20 and the workpiece or adjacent cutting tools set in the tool post, enabling a further increase in the installation density of cutting tools on the tool post, and thereby enhancing productivity.

### Second Embodiment

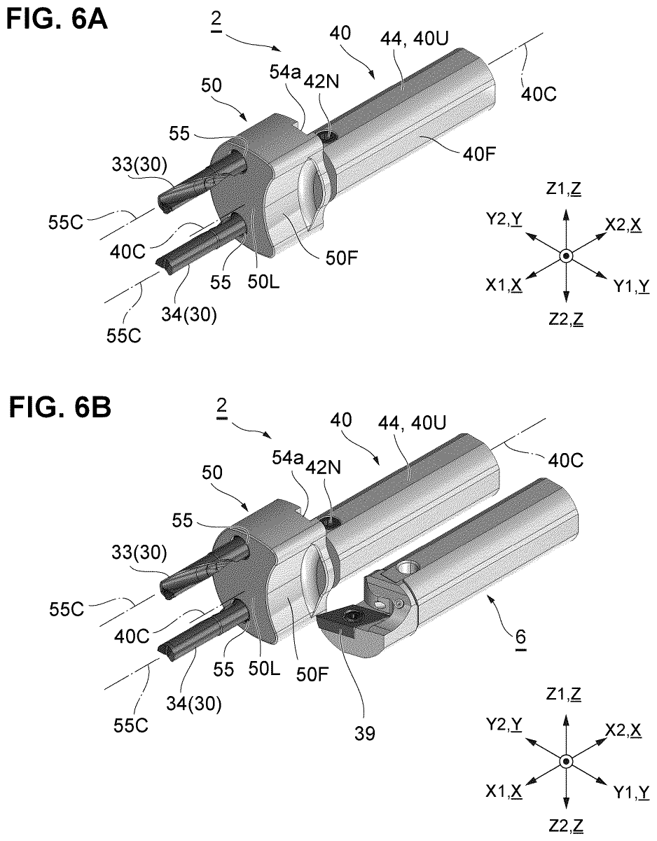

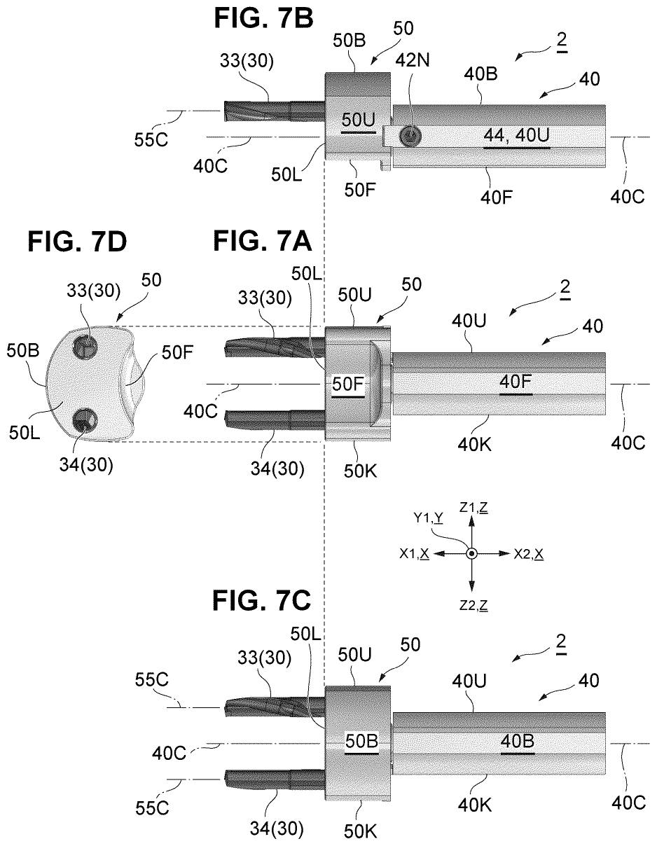

FIG. 6A is a perspective view illustrating a cutting tool 2 according to a second embodiment, and FIG. 6B is a perspective view illustrating the cutting tool 2 and another cutting tool 6 placed adjacent each other. FIG. 7A to FIG. 7D are a right side view, a top view, a left side view, and a front view, respectively, illustrating the cutting tool 2. The coordinate axes shown in FIG. 7A to FIG. 7D apply to FIG. 7A.

As illustrated in these drawings, the cutting tool 2 according to this embodiment includes a shank member 40, two heads 50 (only one shown), and cutting members 30. The shank member 40 is a substantially rod-like member extending linearly (in the front and back direction X) similarly to the shank member 10 except for screws 42N provided in an upper wall 44 unlike the screws 22N in the side wall 14. The right side surface 40F, left side surface 40B, and the lower surface 40K of the shank member 40 have a flat surface similar to that of the upper surface 10U, lower surface 10K, and left side surface 10B of the shank member 10.

Similarly to the head 20 having two mounting holes 25 in a portion other than the projected part 21, the head 50 includes two mounting holes 55 in the front surface 50L. Unlike the right side surface 20F of the head 20, the right side surface 50F is a curved surface. The right side surface 50F is a concave surface having a predetermined radius of curvature, with the central portion of the concave surface being the lowest toward a virtual plane that includes the central axes 55C of the mounting holes 55. The left side surface 50B of the head 50 is also a curved surface similar to the right side surface 50F as shown in FIG. 7D, but it is a convex surface protruding to the left Y2. The upper surface 50U and lower surface 50K of the head 50 are substantially flat. Further, the central axes 55C of the mounting holes 55 are offset from the longitudinal central axis 40C of the shank member 40 toward the opposite side (left Y2) from the side on which the curved right side surface 50F is formed (right side Y1). Rod-like tools 33 and 34 that are part of the cutting member 30 (an example of “a substantially rod-like cutting member” in the present disclosure) are fixedly mounted in the mounting holes 55.

The exchangeable-head cutting tool 2 according to the second embodiment of the present disclosure is configured as described above such that the head 50 is removably mounted on the shank member 40. Therefore, similarly to the cutting tool 1, even if the head 50 is configured to receive the rod-like tools 33 and 34, it allows the cutting tool to be set in the tool post 9. Restrictions imposed by the tool post specification are thus overcome, allowing an increase in the variety and number of the rod-like tools 33 and 34 that can be set in the tool post, and enabling tool exchange regardless of tool post type. Therefore, similarly to the head 20 and cutting tool 1 of the first embodiment, various types of machining processes can be performed efficiently on a workpiece, thereby improving productivity.

When the cutting tool 6 is placed adjacent the cutting tool 2 as shown in FIG. 6B, the machining target such as a rod-like workpiece (not shown) can be positioned between the right side surface 50F that is a curved surface and the cutting member 39 mounted on the cutting tool 6. This allows the head 50 to avoid interfering with the workpiece. Therefore, while preventing interference between cutting tools, the installation density of cutting tools on the tool post is increased, thereby enhancing the machining operation efficiency. Moreover, since the screws 42N are provided in the upper wall 44 of the shank member 40, the head 50 can readily be attached and detached even in a situation shown in FIG. 6B.

### Third and Fourth Embodiments

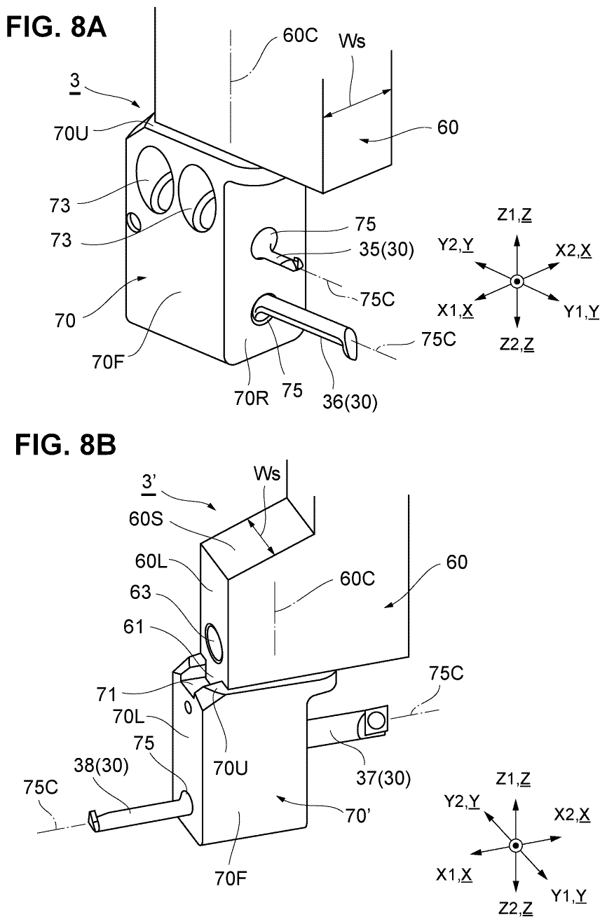

FIG. 8A is a perspective view illustrating a cutting tool 3 according to a third embodiment, and FIG. 8B is a perspective view illustrating a cutting tool 3′ according to a fourth embodiment. The cutting tool 3 illustrated in FIG. 8A includes a shank member 60, a head 70, and a cutting member 30 composed of rod-like tools 35 and 36. The cutting tool 3′ illustrated in FIG. 8B includes a shank member 60, a head 70′, and a cutting member 30 composed of rod-like tools 37 and 38. Although not shown entirely, the shank member 60 used for these tools is a square rod-like member extending in the up and down direction Z, and includes a stepped portion 60S. The shank member is held on a plurality of seats in a gang-type tool, for example.

On the lower side Z2 (lower surface) of the stepped portion 60S is formed a projected part 61, as well as a mounting hole (not shown) in which a projected part (not shown) of the head 70 or 70′ (an example of a portion of a “mounting part” in the present disclosure) is inserted. The stepped portion 60S has a screw hole 63 in its front surface 60L, extending through to the mounting hole. A screw (not shown) is inserted in the screw hole to secure the head 70 or 70′ to the shank member 60.

The head 70 or 70′ is substantially cuboidal except for the projected part (not shown), and includes a recessed part 71 in the upper surface 70U, for the projected part 61 of the shank member 60 to fit in. On the upper surface 70U is provided a projected part (not shown) protruding upward Z1 to be inserted into the mounting hole of the shank member 60. Further, the rear surface 70R of the head 70 is formed with mounting holes 75 configured to receive the rod-like tools 35 and 36 (FIG. 8A). On the other hand, the head 70′ has a mounting hole 75 configured to receive the rod-like tool 37 in the rear surface 70R, and a mounting hole 75 configured to receive the rod-like tool 38 in the front surface 70L.

These mounting holes 75 have their central axes 75C extending substantially perpendicular (orthogonal) to the direction 60C (up and down direction Z) in which the head 70 or 70′ is fixed to the shank member 60. As illustrated, the central axes 75C of the mounting holes 75 are located within the thickness Ws (width) of the shank member 60. Moreover, the right side surface 70F of the head 70 has screw holes 73 extending laterally through to the mounting hole 75 (FIG. 8A). Screws (not shown) are inserted in these screw holes 73 to secure the rod-like tool 35 to the head 70. The left side surface opposite the right side surface 70F has screw holes, in which screws are inserted for securing the rod-like tool 36 to the head 70 (FIG. 8A). On the other hand, the left side surface opposite the right side surface 70F of the head 70′ has screw holes extending through to the mounting hole 75, and screws are inserted in the screw holes for securing the rod-like tools 37 and 38 to the head 70′ (FIG. 8B).

The exchangeable-head cutting tool 3 or 3′ according to the third or fourth embodiment of the present disclosure is configured as described above such that the head 70 or 70′ is removably mounted on the shank member 60. Therefore, similarly to the cutting tools 1 and 2, a plurality of rod-like tools 35 and 36, or 37 and 38 can be mounted on the shank member 60 that is held in the tool post. Restrictions imposed by the tool post specification are thus overcome, allowing an increase in the type and number of the rod-like tools 35, 36, 37, and 38 that can be set in the tool post, and enabling tool exchange regardless of tool post type. Therefore, similarly to the head 20 and cutting tool 1 of the first embodiment, or the head 50 and cutting tool 2 of the second embodiment, various types of machining processes can be performed efficiently on a workpiece, thereby improving productivity.

The mounting holes 75 have their central axes 75C extending substantially perpendicular to the direction 60C (up and down direction Z) in which the head 70 or 70′ is fixed to the shank member 60. This configuration enables a further size reduction of the head 70 or 70′. This reliably prevents interference between the head 70 or 70′ and the workpiece or adjacent cutting tools set in the tool post, enabling a further increase in the installation density of cutting tools on the tool post, and thereby enhancing productivity. These mounting holes 75 enable configuration of a head that can efficiently perform various types of machining processes with the rod-like tools 35, 36, 37, and 38.

The plurality of mounting holes 75 may be located opposite each other in the head 70 or 70′. This allows cutting members to be protruded in opposite directions from the head, which increases the degree of freedom or flexibility of machining processes on a workpiece.

At least one of the plurality of mounting holes 75 may extend through the head 70 or 70′, or all the mounting holes 75 may extend through the head. In this case, a single hole allows one rod-like tool to be attached in either orientation. Alternatively, a single hole allows two rod-like tools to be attached from both sides. By providing two or more through holes, the number of rod-like tools that can be mounted can be increased even more. A through hole will allow attachment and use of a rod-like tool with cutting edges at both ends.

In addition, the screw holes 73, which the screws engage to secure the rod-like tools 35, 36, 37, and 38 to the head 70 or 70′, are formed to extend laterally through to the mounting holes 75 at a predetermined angle relative to the XZ plane. This allows the screws for securing the rod-like tools 35, 36, 37, and 38 to be accommodated in the head 70 or 70′, so that the head 70 or 70′ can be made even smaller. This configuration also allows the screws and screw holes 73 to be located at positions readily visible from the front or rear, so that the operation of fastening the rod-like tools 35, 36, 37, and 38 to the head 70 or 70′ with the screws can be carried out reliably and easily. At the same time, an effective screw engagement length for the fastening of the rod-like tools 35, 36, 37, and 38 is ensured.

The embodiments have been described above for facilitating the understanding of the present disclosure and not for limiting the interpretation of the present disclosure. Namely, the present disclosure is not necessarily limited to the specific configurations described above. As long as the features of the present disclosure are entailed, any variations with design changes made to these specific configurations as appropriate by those skilled in the art are also included in the scope of the present disclosure. Unless otherwise explicitly specified, various elements, arrangements, materials, conditions, shapes, sizes and scales of the specific configurations described above are not particularly limited to the illustrated examples and may be changed as required. Further, the elements in the specific configurations described above may be variously combined as suited as long as there is no technical inconsistency.

For example, each head 20, 50, 70, or 70′ may be provided with three or more cutting members and mounting holes 25, 55, and 75. The screws 12N, 22N, and 42N need not be countersunk screws. The shank member 10 may not necessarily include the key 14a and key groove 24a. The head 20 may be fastened to the shank member 10 only by fitting the projected part 21 of the head 20 in the recessed part 11 of the shank member 10. Similarly, the shank member 60 may not necessarily include the projected part 61, and the head 70 or 70′ may not include the recessed part 71. The head 70 or 70′ may be fastened to the shank member 60 only by fitting the projected part of the head 70 or 70′ in the mounting hole of the shank member 60. Only one head 20 or 50 may be mounted on the shank member 10. Only some of the mounting holes 25, and not all of them, may have their central axes 25C located within the thickness Ws (width) of the shank member 10.

Focusing on the detailed structure of the head 20, as shown in FIG. 4, the cross-sectional shape perpendicular to the axial direction of the mounting holes 25 or the shape of the side surface (FIGS. 4D and 4E) is a polygon having five or more sides (six sides in the illustrated example), and the plurality of mounting holes 25 are provided on the same surface (front surface 20L). Further, as described above, each of the screw engagement length adjustment surfaces 20M and 21M is provided with a plurality of screw holes for the screws 22N for securing the rod-like tools 31 and 32 to the head 20. In addition, as described above, the rear surface 20R opposite to the front surface 20L where the mounting holes 25 are provided has the projected part 21 protruding therefrom for attachment to the shank member 10, and the projected part 21 is formed with the internal thread portion 21N for fixation to the shank member 10. Furthermore, focusing on the detailed structure of the heads 70 and 70′, as shown in FIG. 8, the right side surface 70F of the heads 70 and 70′ is provided with a plurality of screw holes 73 for screws for securing the rod-like tool 35 or the like to the heads 70 and 70′. The plurality of mounting holes 75 are provided on the same surface (rear surface 70R) or on two opposing surfaces (front surface 70L and rear surface 70R).

The characteristic features of the head according to the present disclosure can also be expressed as follows in relation to the cutting tool of the present disclosure. That is, the head according to the present disclosure is a head for an exchangeable-head cutting tool, wherein the cutting tool is mounted on a tool post and does not rotate, but machines a workpiece by the rotation of the workpiece. The head includes a mounting part to be mounted on a component of the exchangeable-head cutting tool other than the head, and a plurality of mounting holes formed in the same end surface and configured to receive a substantially rod-like cutting member, wherein the central axes of the mounting holes are located within the thickness or the width in the short-side direction of the component. In other words, the head is a head to be mounted on a component of a cutting tool that is premised on being “mounted on a tool post and not rotating, but machining a workpiece by the rotation of the workpiece,” and the head does not rotate during use.

What is claimed is:

1. A head for an exchangeable-head cutting tool, the head comprising:
a mounting part for mounting the head on a component of the exchangeable-head cutting tool other than the head; and
a plurality of mounting holes configured to receive a substantially rod-like cutting member.

2. The head according to claim 1, wherein the head is substantially cuboidal except for the mounting part.

3. The head according to claim 1, wherein the mounting holes each have a central axis located within a width of the component in a direction along a short side of the component.

4. The head according to claim 1, wherein the head includes a screw hole that a screw engages to secure the cutting member to the head, the screw hole extending laterally through to the plurality of mounting holes.

5. The head according to claim 1, wherein the mounting holes each have a central axis substantially parallel to a direction in which the head is fixed to the component.

6. The head according to claim 5, wherein the head includes a screw engagement length adjustment surface in which the screw hole is formed.

7. The head according to claim 5, including a curved surface having a predetermined radius of curvature, wherein a central portion of the curved surface is the lowest toward a virtual plane that includes the central axes of the plurality of mounting holes,
the central axes of the plurality of mounting holes being offset from a longitudinal central axis of the component toward an opposite side from a side on which the curved surface is formed.

8. The head according to claim 1, wherein the mounting holes each have a central axis substantially perpendicular to a direction in which the head is fixed to the component.

9. The head according to claim 8, wherein the plurality of mounting holes are located opposite each other in the head.

10. The head according to claim 8, wherein at least one of the plurality of mounting holes extends through the head.

11. The head according to claim 8, wherein all of the plurality of mounting holes extend through the head.

12. An exchangeable-head cutting tool comprising:
a head having a mounting part and a plurality of mounting holes configured to receive a substantially rod-like cutting member; and
a component formed in an elongated shape and having the head mounted on both ends thereof.

13. The head according to claim 1, wherein a cross-sectional shape perpendicular to an axial direction of the mounting holes or a shape of a side surface is a polygon having five or more sides.

14. The head according to claim 1, wherein the plurality of mounting holes are provided in a same surface or in two surfaces opposite to each other.

15. The head according to claim 6, wherein a plurality of the screw holes are formed in one said screw engagement length adjustment surface.

16. The head according to claim 1, wherein a projected part for attachment to another member protrudes from a surface opposite to a surface in which the plurality of mounting holes are provided, and wherein an internal thread portion for fixation to the other member is formed in the projected part.
